(19) United States
(12) Patent Application Publication
(10) Pub. No.: US 2013/0284524 A1
(43) Pub. Date: Oct. 31, 2013

(54) POWER SYSTEM FOR VEHICLES AND FACILITIES

(71) Applicant: WALTER COLLINS, Sacramento, CA (US)

(72) Inventor: WALTER COLLINS, Sacramento, CA (US)

(21) Appl. No.: 13/601,590

(22) Filed: Aug. 31, 2012

Related U.S. Application Data
(60) Provisional application No. 61/573,118, filed on Sep. 6, 2011.

(51) Int. Cl. B60L 8/00; B60K 6/46

(52) U.S. Cl. 180/2.2; 180/65.245; 903/903

(57) ABSTRACT

A power system for a vehicle or a facility utilizing an electric traction motor which is operated by a bank of batteries. The batteries are charged by a fuel operated electrical generator which is cooled by a radiator. A solar cell provides additional electrical output to the bank of batteries, while a ram air turbine may be employed for added electrical power or for regenerative braking. The traction motor operates a drive shaft through a differential gear mechanism to operate the wheels of the vehicle.

### CROSS-REFERENCES TO RELATED APPLICATION

The present invention claims the benefit of Provisional Patent Application Ser. No.: 61/573,118, filed 6 Sep. 2011, which is incorporated by reference, as a whole, to the present application.

### BACKGROUND OF THE INVENTION

The present invention relates to a novel and useful power system for a vehicle or a facility operated by a traction motor by modification of an existing vehicle or by original construction.

In the past, vehicles such as eighteen wheelers, buses and the like have been operated by using diesel engines. Although a diesel engine provides sufficient power to operate such large vehicles, they are now regarded as being expensive, inefficient, and polluting.

In the past, electrically operated vehicles have been employed, obtaining electrical power either through the use of pre-charged batteries, overhead electrical lines or generators, sources of electricity provide electrical energy to run vehicle electrical motors. In the past, many such systems have been proposed.

For example, U.S. Patent Publication 2001/0004363, U.S. Pat. No. 7,228,841, and China Patent Publication 200820301830.8 describe controls for switching internal combustion engines in which multiple sources of energy are employed.

U.S. Pat. No. 6,508,321, China Patent Publication 1644907, and Japan Patent Publication 2010-000894 show drive systems for a hybrid vehicle using electrical and fuel sources to provide- motivational power.

U.S. Pat. Nos. 4,531,497, 5,081,977, 5,147,005, and 5,884,488 teach vehicles which employ natural gas systems to operate the same.

U.S. Pat. Nos. 5,172,784, and 7,597,164 as well as International Publication No: WO2010/151828 illustrate hybrid vehicle systems which include a traction motor, starting motor, and a battery bank. Generators are also used which may burn natural gas or gasoline to provide electrical power to such vehicles.

A vehicle employing multiple components that are capable of generating electrical power to a traction motor to operate such vehicle would be a notable advance in the automotive field.

### SUMMARY OF THE INVENTION

In accordance with the present invention a novel and useful power system for new or modified vehicles and facilities is herein provided.

The system of the present invention utilizes the combination of a traction motor which provides power along a drive shaft to a differential that operates the wheels of a vehicle. The traction motor is operated by a block of batteries which are charged by a fuel operated generator, a solar cell, or an air turbine. Cooling of the generator is obtained by use of either an air or liquid radiator. The vehicle of the present invention also utilizes an air tank which may be employed to provide braking for the vehicle.

Likewise, the voltage generated by the air turbine may also be used to produce a back EMF in the traction motor that may be utilized to provide braking. In certain cases, regenerative braking may also be included in the propulsion system of the present invention when the vehicle is traveling in a downhill manner, to aid in the charging of the batteries used to run the traction motor component.

The above described propulsion system may be applied by modifying existing vehicles or through the manufacture of original vehicles. The former case may require downsizing of existing traction motors, such as those used in locomotives.

In certain instances, the block of batteries may be linked to a facility to provide emergency power when needed.

It may be apparent that an invention that utilizes features which have not been realized in the prior art and exhibits certain advantages, which are novel in the field, has been hereinabove described.

It is therefore an object of the present invention to provide a vehicle propulsion system which employs a traction motor that is operated by batteries and alternative sources of electrical power.

Another object of the present invention is to provide a vehicle propulsion system which employs solar and wind movement derived power in combination with a fuel operated generator.

A further object of the present invention is to provide a vehicle propulsion system which may utilize regenerative braking through the use of electrical voltage generated by a turbine.

A further object of the present invention is to provide a vehicle propulsion system that is highly efficient and relatively free of maintenance and, yet, is able to produce sufficient power to a large vehicle.

Another object of the present invention is to provide a large vehicle propulsion system which is very economical to operate.

Yet another object of the present invention is to provide a propulsion system that may provide emergency electrical power to businesses, schools, and residents during power outages.

The invention possesses other objects and advantages especially as concerns particular characteristics and features thereof which will become apparent as the specification continues.

### BRIEF DESCRIPTION OF THE SEVERAL VIEWS OF THE DRAWING

FIG. 1 represents a schematic side view of a vehicle utilizing the propulsion system of the present invention.

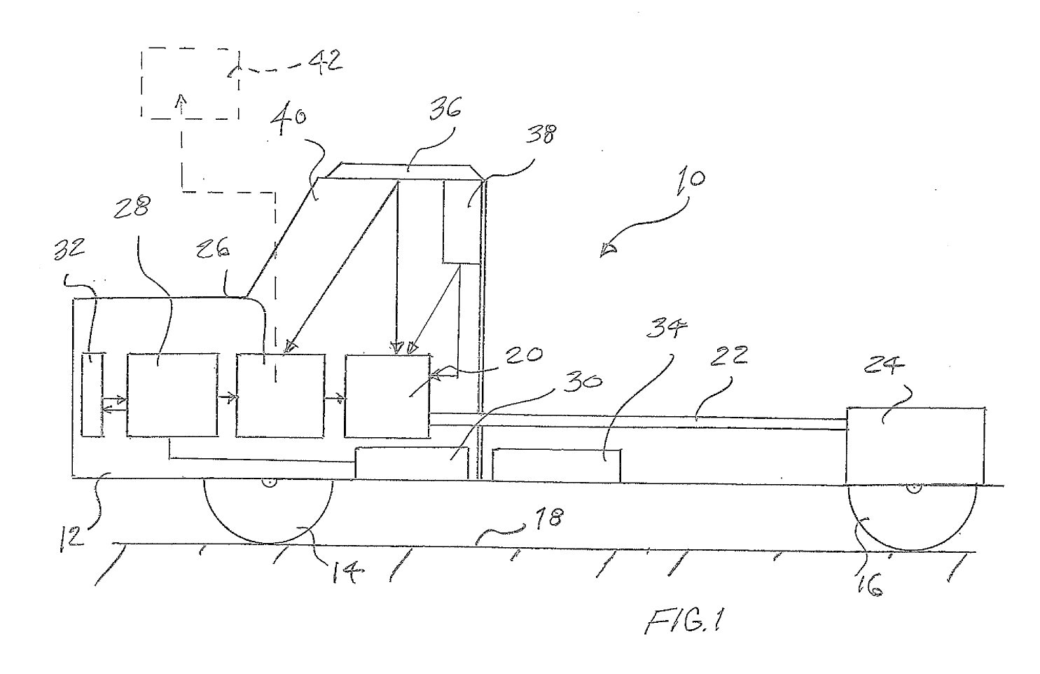

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

The invention as a whole is shown in the drawings by reference character 10. Vehicle 10 represents a large vehicle such as an eighteen wheeler truck, a bus, and the like. Vehicle 10 includes a conventional frame 12, having pairs of exemplary front and rear wheels 14 and 16, respectively, that ride on surface 18. Traction motor 20 lies on frame 12 and sends power through a drive shaft 22 to differential 24, which is mechanically connected to rear wheels 16. Of course, vehicle 10 may be operated through the transfer of power from traction motor 20 to front wheels 14, as the case may be. Traction motor 20 may be of the type normally employed in rail vehicles, such as electric locomotives. Normally, traction motors are series-wound brushed DC motors. However, high reliability AC induction motors, known as asynchronous traction motors, may also be employed. Traction motor 20 is operated through a block of batteries or a battery bank or pack 26 which is charged through an electrical generator 28. Fuel tank 30 provides the necessary energy source to operate electrical generator 28 when electrical generator is motivated by an internal combustion engine. Radiator 32 in the front portion of vehicle 10 cools electrical generator 28.

Compressed air tank 34 is also found in vehicle 10 and may be employed for braking conventional air brakes associated with pairs of wheels 14 and 16.

In addition, solar panel 36 mounted atop vehicle 10 may be fashioned to generate electrical energy or power to charge battery pack 26 or to directly run traction motor 20.

Further, a pair of ram air turbines 38 (one shown) located on the opposite sides of the outside of cab 40 of vehicle 10 captures moving air and translates the same into electrical energy or power. Such electrical power is either transmitted to battery pack 26 or directly to traction motor 20. It should be noted that such electrical power generated by the pair of ram air turbine 38 may also be used to aid in braking through the generation of a back EMF on traction motor 20. In addition, vehicle 10 may be fitted with regenerative braking components, known in the art.

In addition, when charged, battery pack 26 may be linked to a facility 42, such as a business edifice, school or residence, to provide emergency electrical power during power outages.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

1. A vehicle apparatus having a frame movable on a plurality of wheels and supporting a cab, the vehicle further including a propulsion system, the propulsion system comprising:
a. a traction motor;
b. a battery pack said battery pack providing electrical power to said traction motor;
c. an electrical generator, said electrical generator transferring electrical energy to said battery pack;
d. a solar panel mounted to the vehicle, said solar panel generating electrical energy, said electrical energy generated by said solar panel being selectively directed to said traction motor and said battery pack; and
e. a ram air turbine located on said vehicle, said ram air turbine generating electrical energy, said electrical energy generated by said ram air turbine being selectively directed to said traction motor and said battery pack.

2. The apparatus of claim 1 in which said generator further comprises an internal combustion engine.

3. The apparatus of claim 2 which further comprises a fuel tank mounted to said vehicle.

4. The apparatus of claim 1 which further comprises a compressed air tank.

5. The apparatus of claim 1 which further comprises a radiator cooling said electrical generator.

6. The apparatus of claim 1 in which said battery pack is linked to a facility to provide electrical energy thereto.

7. The apparatus of claim 5 in which said generator further comprises an internal combustion engine.

8. The apparatus of claim 6 which further comprises a fuel tank mounted to said vehicle.

9. The apparatus of claim 5 which further comprises a compressed air tank.

10. The apparatus of claim 5 which further comprises a radiator cooling said electrical generator.
